(19) United States
(12) Patent Application Publication
(10) Pub. No.: US 2026/0274322 A1
(43) Pub. Date: Sep. 17, 2026

(54) CHILD TRANSPORTER

(71) Applicant: Dorel Juvenile Group, Inc., Foxboro, MA (US)

(72) Inventors: John HUNTLEY, Providence, RI (US); Grant M. MASON, Wrentham, MA (US); Kelly CHAMBERLIN, North Attleboro, MA (US)

(21) Appl. No.: 19/563,367

(22) Filed: Mar. 11, 2026

Related U.S. Application Data
(60) Provisional application No. 63/770,653, filed on Mar. 12, 2025.

(51) Int. Cl. B62B 7/14; B62B 7/00; B62B 9/20

(52) U.S. Cl. CPC B62B 7/142; B62B 7/008; B62B 9/20

(57) ABSTRACT

A child transporter includes a mobile cart and a juvenile seat coupled removably to the mobile cart. The mobile cart includes a frame and a plurality of wheels coupled to the frame to support the frame for movement across ground. The child transporter further includes a seat-mode controller coupled to the frame and configured to mount the juvenile seat to the frame.

### PRIORITY CLAIM

This application claims priority under 35 U.S.C. § 119(e) to U.S. Provisional Patent Application No. 63/770,653, filed March 12, 2025, which is expressly incorporated by reference herein in its entirety.

### BACKGROUND

The present disclosure relates to a child safety device, and particularly to a child transporter. More particularly, the present disclosure relates to a child transporter including multiple modes of operation.

### SUMMARY

According to the present disclosure, a child transporter includes a mobile cart and a juvenile seat coupled removably to the mobile cart. The mobile cart includes a frame, a plurality of wheels coupled to the frame to support the frame for movement across ground, and a front seat mount coupled to a front end of the frame. The frame includes a handlebar configured to be gripped by a caregiver to push the mobile cart over the ground, a front frame section coupled to the handlebar and a pair of front wheels included in the plurality of wheels, and a rear frame section coupled to the front frame section and a pair of rear wheels included in the plurality of wheels.

In illustrative embodiments, the child transporter further includes a seat-mode controller coupled to the rear frame section. The seat-mode controller is configured to mount the juvenile seat to the frame for pivotable movement relative to the rear frame section about a controller pivot axis to change the child transporter from a single-function mode and a dual-function mode. In the single-function mode, the juvenile seat is positioned a first distance from a front end of the mobile cart. In the dual-function mode, the juvenile seat is positioned a second distance, greater than the first distance, from the front end of the mobile cart.

In illustrative embodiments, the juvenile seat is a first juvenile seat and the child transporter further includes a second juvenile seat configured to be mounted to the front seat mount when the mobile cart is in the dual-function mode so that the second juvenile seat can be transported with the first juvenile seat on the mobile cart. The seat-mode controller pivots a second seat mount away from the front seat mount in the dual-function mode to provide more spacing therebetween to accommodate the first and second juvenile seats.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a child transporter, in accordance with the present disclosure, including a mobile cart and a juvenile seat coupled to the mobile cart via a seat-mode controller, the mobile cart having a frame and a plurality of wheels and the seat-mode controller configured to provide an adjustable seat position for the juvenile seat relative to the frame so that the child transporter may assume a plurality of modes as suggested in FIG. 3;

FIG. 2 is a perspective view of the mobile cart with the juvenile seat removed to show the seat-mode controller coupled to the frame for pivotable movement about a horizontal controller pivot axis relative to the mobile cart to adjust a spacing between the juvenile seat and a front end of the mobile cart, and showing a second seat mount coupled to the frame at or near the front end of the mobile cart and configured to attach a second juvenile seat thereto when the seat-mode controller positions the juvenile seat with sufficient spacing therebetween;

FIG. 3 is a side view of the mobile cart of FIG. 1 showing the seat-mode controller arranged in each of a first single-function mode, a second single-function mode, a first dual-function mode, a second dual-function mode, and a third dual-function mode;

FIG. 4 is an enlarged perspective view of a portion of the mobile cart and the seat-mode controller in the first single-function mode showing the seat-mode controller including a first connector rod coupled to a first lateral side of the frame, a second connector rod coupled to a second lateral side of the frame, and a seat mount coupled to a distal end of the first and second connector rods and configured to attach to the juvenile seat;

FIG. 5 is an enlarged perspective view of a portion of the mobile cart and the seat-mode controller in the first dual-function mode showing the seat mount including a first seat anchor coupled to the first connector rod, a second seat anchor coupled to the second connector rod, and an anchor position controller coupled to the first seat anchor and the second seat anchor and configured to adjust an orientation of the first seat anchor and the second seat relative to the first and second connector rods as the seat-mode controller pivots about the connector pivot axis;

FIG. 6 is a perspective view of the child transporter showing the mobile cart in the first single-function mode and showing the juvenile seat coupled to the seat-mode controller;

FIG. 7 is a side view of the mobile cart of FIG. 6 in the first single-function mode in which the seat mount is spaced a first distance from a front end of the mobile cart;

FIG. 8 is a perspective view of the mobile cart of FIG. 6 in the first single-function mode;

FIG. 9 is a perspective view of the child transporter showing the mobile cart in the first dual-function mode, and showing the juvenile seat coupled to the seat-mode controller and a second juvenile seat is coupled to a front seat attachment and spaced in front of the juvenile seat;

FIG. 10 is a side view of the mobile cart of FIG. 9 in the first dual-function mode in which the seat mount is spaced a second distance greater than the first distance from the front end of the mobile cart;

FIG. 11 is a perspective view of the mobile cart of FIG. 9 in the first dual-function mode;

FIG. 12 is a side view of the mobile cart of FIG. 2 in the second dual-function mode in which the seat mount is spaced a third distance greater than the second distance from the front end of the mobile cart;

FIG. 13 is a side view of the mobile cart of FIG. 2 in the third dual-function mode in which the seat mount is spaced a fourth distance greater than the third distance from the front end of the mobile cart;

FIG. 14 is a perspective view of the child transporter in the first dual-function mode showing the first juvenile seat and the second juvenile seat in a rearward-facing orientation;

FIG. 15 is a perspective view of the mobile cart in the first dual-function mode showing the first juvenile seat as an infant carrier and the second juvenile seat as a toddler seat;

FIG. 16 is a perspective view of a second embodiment of an actuator for the seat-mode controller including a single actuator to unlock the seat-mode controller for pivotal movement about a controller pivot axis and to unlock first and second seat anchors for pivotal movement about an anchor pivot axis;

FIG. 17 is a perspective view of a third embodiment of an actuator for a seat-mode controller showing a crossbar omitted;

FIG. 18 is a perspective view of a fourth embodiment of an actuator for a seat-mode controller including first and second release buttons at a distal end of each connector rod to unlock the seat-mode controller for pivotal movement about a controller pivot axis and to unlock first and second seat anchors for pivotal movement about an anchor pivot axis;

FIG. 19 is a side view of a second embodiment of a mobile cart including a seat-mode controller having a first connector rod, a second connector rod, and a seat mount in the form of a tray coupled to the first and second connector rods;

FIG. 20 is a side view of a third embodiment of a mobile cart including a seat-mode controller having a first connector rod, a second connector rod, and a seat mount in the form of a tray coupled to the first and second connector rods, the first and second connector rods each including a plurality of linkages so that spacing between the tray and a controller pivot axis can be adjusted.

### DETAILED DESCRIPTION

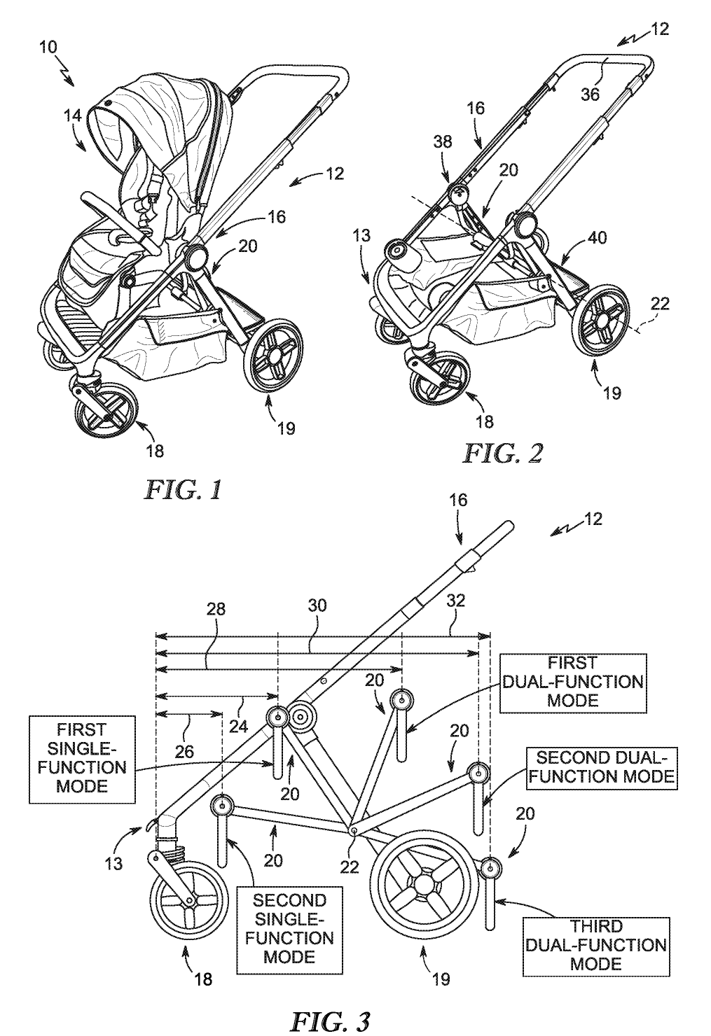

A child transporter 10 includes a mobile cart 12 and a juvenile seat 14 configured to be coupled to the mobile cart for transportation over ground as shown in FIG. 1. The mobile cart 12 includes a frame 16 and a plurality of wheels 18, 19 coupled to the frame 16 and configured to roll over the ground. In the illustrative embodiment, the child transporter 10 is a juvenile stroller, however other child transporters are also contemplated including a wagon, for example.

The juvenile seat 14 is repositionable relative to the mobile cart 12 so that the child transporter 10 can assume and be used in a plurality of operational modes. The child transporter 10 further include a seat-mode controller 20 coupled to the frame 16. The seat-mode controller 20 is configured to mount the juvenile seat 14 to the mobile cart 12 for pivotable movement relative to the frame about a controller pivot axis 22 to change the child transporter 10 between the plurality of modes.

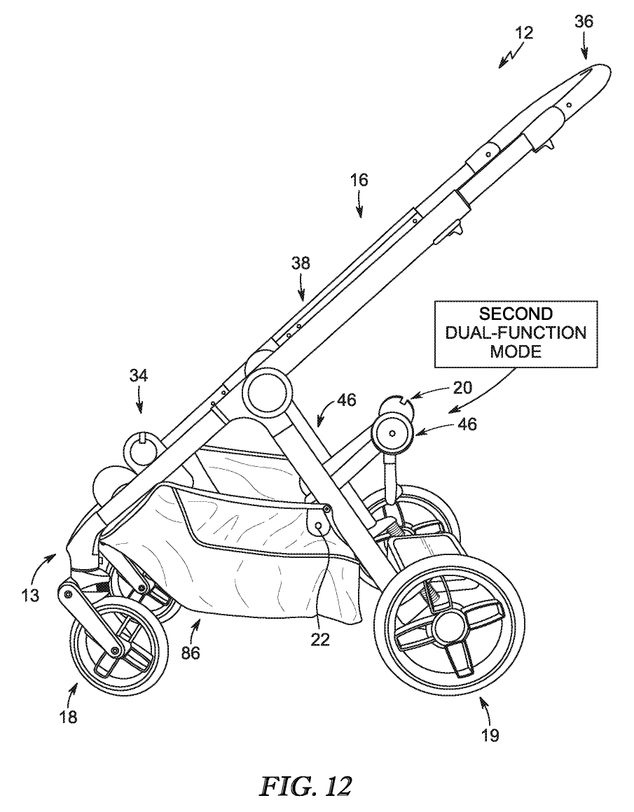

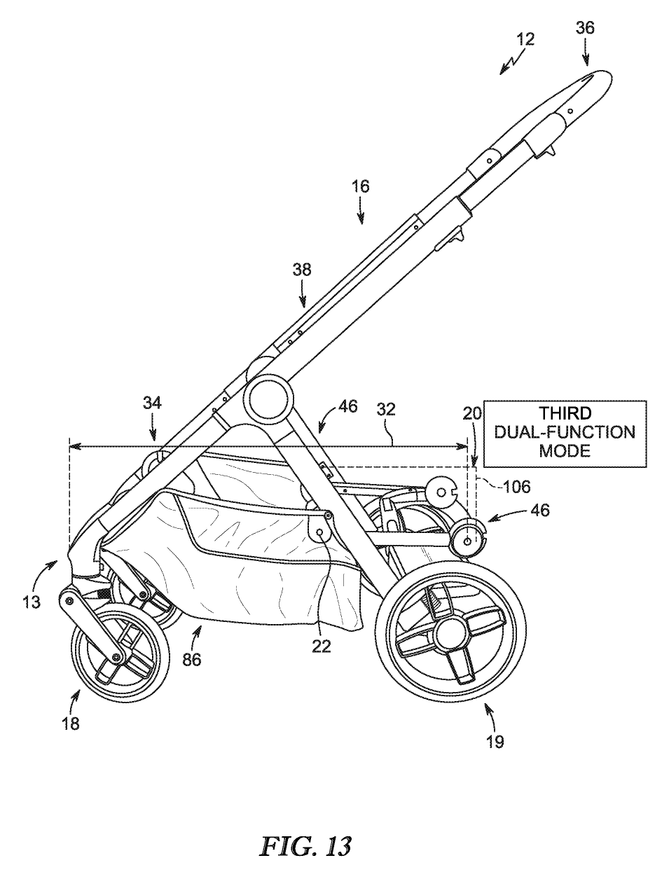

In the illustrative embodiment, the seat-mode controller 20 is or includes an articulating seat attachment having a first end pivotally coupled to the frame 16 and an opposite second end configured to secure the juvenile seat 14 thereto for pivotal movement with the articulating seat attachment. The seat-mode controller 20 is configured to pivot the juvenile seat 14 about the controller pivot axis 22 so that the juvenile seat 14 can assume: (i) a first single-function mode, (ii) a second single-function mode, (iii) a first dual-function mode, (iv) a second dual-function mode, and/or (v) a third dual-function mode. In the first single-function mode, the seat-mode controller 20 positions the juvenile seat 14 a first distance 24 from a front end 13 of the frame 16 as shown in FIGS. 1-4 and 6-8. In the second single-function mode, the seat-mode controller 20 positions the juvenile seat 14 a second distance 26, less than the first distance 24, from the front end 13 of the frame 16 as shown in FIG. 2. In the first dual-function mode, the seat-mode controller 20 positions the juvenile seat 14 a third distance 28, greater than the second distance 26, from the front end 13 of the frame 16 as shown in FIGS. 2, 5, and 9-11, . In the second dual-function mode, the seat-mode controller 20 positions the juvenile seat 14 a fourth distance 30, greater than the third distance 28, from the front end 13 of the frame 16 as shown in FIGS. 2 and 12. In the third dual-function mode, the seat-mode controller 20 positions the juvenile seat 14 a fifth distance 32, greater than the fourth distance 30, from the front end 13 of the frame 16 as shown in FIGS. 2 and 13.

When the child transporter 10 is in the first or second single-function mode, the juvenile seat 14 is attached directly to the seat-mode-controller 20 and is the only juvenile seat attached to the mobile cart 12. The juvenile seat 14 and the seat-mode controller 20 are able to assume the positions of the first, second, and third dual-function modes while the juvenile seat 14 is still the only juvenile seat attached to the mobile cart 12. In this way, the seat-mode controller 20 provides increased position variability for the juvenile seat 14 relative to the frame 16 to improve comfort for a child seated in the juvenile seat 14 or a caregiver operating the child transporter 10.

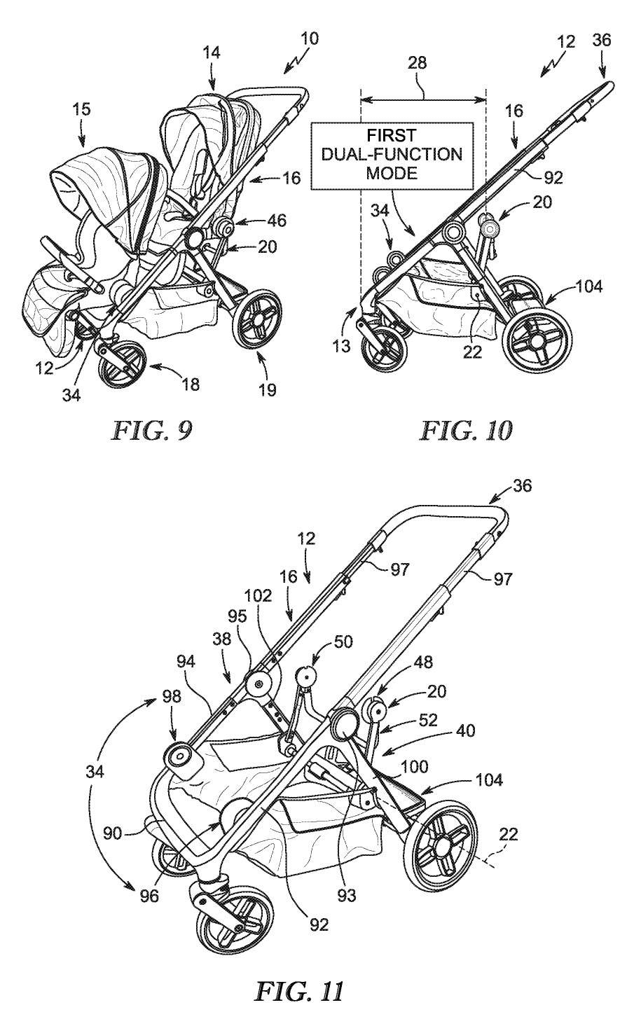

In the illustrative embodiment, the mobile cart 12 further includes a front seat mount 34 coupled to the frame 16 and spaced apart from the seat-mode controller 20 as shown in FIGS. 1-3. The child transporter 10 may include a second juvenile seat 15, as shown in FIG. 9, configured to mount on the front seat mount 34 when the child transporter 10 is in the first, second, or third dual-function mode. The front seat mount 34 is coupled to the front end 13 of the frame 16. The seat-mode controller 20 allows the juvenile seat 14 to move rearward away from the front seat mount 34 to provide sufficient spacing for the juvenile seats 14, 15 to be secured to the mobile cart 12 together.

The frame 16 includes a handlebar 36, a front frame section 38, and a rear frame section 40 as shown in FIGS. 1-5. The handlebar 36 is configured to be gripped by a caregiver to push the mobile cart 12 over the ground. The front frame section 38 is coupled to the handlebar 36 and a pair of front wheels 18 included in the plurality of wheels. The rear frame section 40 is coupled to the front frame section 38 and a pair of rear wheels 19 included in the plurality of wheels. The seat-mode controller 20 is coupled to the rear frame section 40.

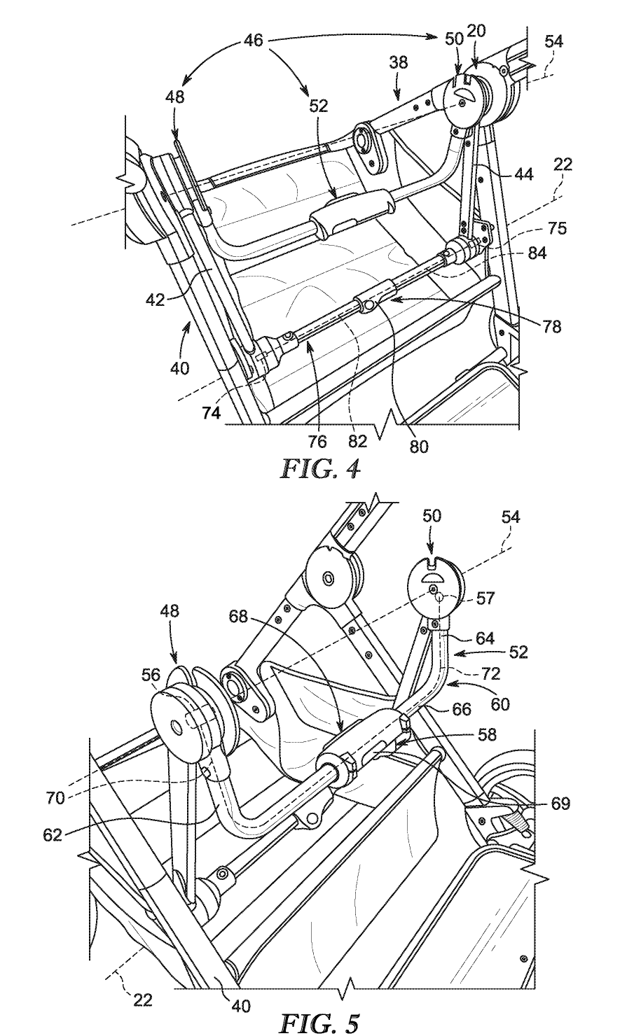

The seat-mode controller 20 includes a first connector rod 42, a second connector rod 44, and a second seat mount 46 as shown in FIGS. 4 and 5. The first connector rod 42 is coupled to a first lateral side of the rear frame section 40. The second connector rod 44 is coupled to a second lateral side of the rear frame section 40. The second seat mount 46 is coupled to a distal end of the first connector rod 42 and the second connector rod 44 and is configured to mount the first juvenile seat 14 to the seat-mode controller 20. In some embodiments, the first and second connector rods 42, 44 may include multiple parts or sections that are telescopic or translatable relative to one another to increase and decrease a length of the connector rods 42, 44 and a distance of the seat mount 46 from the controller pivot axis 22.

The second seat mount 46 includes a first seat anchor 48 coupled to the distal end of the first connector rod 42, a second seat anchor 50 coupled to the distal end of the second connector rod 44, and an anchor position controller 52 as shown in FIGS. 4 and 5. The first and second seat anchors 48, 50 are substantially similar to one another and can include any suitable structure to secure the juvenile seat 14 in place on the mobile cart 12 such as a post, notch, hook, etc. or a combination thereof. The first and second seat anchors 48, 50 are configured to attach to a corresponding structure on the juvenile seat 14, such as a cavity, notch, bar, latch, etc. or a combination thereof.

In the illustrative embodiment, the juvenile seat 14 is attached to the seat-mode controller 20 by lowering the juvenile seat 14 onto the first and second anchors 48, 50 so that the seat anchors 48, 50 extend at least partially into cavities formed in the juvenile seat 14. Because of this, the seat anchors 48, 50 are preferably oriented to receive the juvenile seat 14 in a vertical direction to facilitate this installation and also position the juvenile seat 14 in an upright position ready to receive a child after installation. The anchor position controller 52 is configured to pivot at least a portion of the first seat anchor 48 and the second seat anchor 50 relative to the first connector rod 42 and the second connector rod 44 about an anchor pivot axis 54 based on the angular orientation of the seat-mode controller pivots 20 about the controller pivot axis 22 so that the first seat anchor 48 and the second seat anchor 50 provide a level mounting position for the first juvenile seat 14 in both the single function mode(s) and the dual function mode(s). The anchor position controller 52 also allows a user to adjust a recline orientation of the juvenile seat 14 relative to the mobile cart 12 to improve comfort for the child seated in the juvenile seat 14.

The anchor position controller 52 includes a pair of anchor latches 56, 57 an actuator 58, and a pivot lever 60 as shown in FIGS. 4 and 5. The pair of anchor latches 56, 57 are coupled to the first and second seat anchors 48, 50, respectively. The anchor latches 56, 57 project outward away from one another and engage the first and second connector rods 42, 44 in a locked position to block pivotable movement of the first and second seat anchors 48, 50 about the anchor pivot axis 54. The actuator 58 is coupled to the anchor latches 56, 57 and is coupled to the pivot lever 60 for movement therewith. The actuator 58 is configured to move the anchor latches 56, 57 from the locked position to an unlocked position, in which the first seat anchor 48 and the second seat anchor 50 are free to pivot about the anchor pivot axis 54. The pivot lever 60 includes a first lever arm 62 coupled to the first seat anchor 48, a second lever arm 64 coupled to the second seat anchor 50, and a lever crossbar 66 interconnecting the first lever arm 62 and the second lever arm 64 and spaced apart from the first seat anchor 48 and the second seat anchor 50 to provide spacing from the juvenile seat 14 to access the actuator 58.

The actuator 58 includes a latch release 68 and first and second latch movers or cables 70, 72 coupled to the anchor latches 56, 57, respectively as shown in FIG. 5. The latch release 68 illustratively includes a button that is pressed by a user to pull the cables 70, 72 and, hence, the latches 56, 57, inward to the unlocked position. One or more springs or other suitable resilient elements may be included to bias the latch release 68 and/or the anchor latches 56, 57 toward the locked position. The actuator 58 may further include a secondary latch release 69 (i.e. a slider or secondary button) that is first moved to an unlocked position before the latch release 68 can be actuated. In some embodiments, the pivot lever 60 includes hollow tubing and the latch movers or cables 70, 72 extend through an interior of the hollow tubing to the anchor latches 56, 57.

The seat-mode controller 20 may further include a controller crossbar 76 extending between and interconnecting a proximal end of the first connector rod 42 and the second connector rod 44 along the controller pivot axis 22 and a second actuator 78 coupled to the crossbar 76 as shown in FIGS. 4 and 5. The controller crossbar 76 supports and rigidifies the connection between the seat-mode controller 20 and the frame 16. The second actuator 78 is configured to unlock the seat-pivot controller 20 for pivotable movement relative to the frame 16 about the controller pivot axis 22. The second actuator 78 may include a handle 80 and one or more movers or cables 82, 84 coupled to the handle 80 and secondary latches 74, 75 extending between the crossbar 76 and the frame 16. Illustratively, movement or rotation of the handle 80 causes movement of the cables 82, 84 to actuate the secondary latches 74, 75 to disengage from the frame 16 and free the seat-mode controller 20 for pivotable movement about the controller pivot axis 22.

The mobile cart 12 may further include a storage basin 86 coupled to the frame 16 and positioned below the juvenile seat 14 as shown in FIGS. 4 and 5. The juvenile seat 14 is movable by way of the seat-mode controller 20 to provide clearer access to the storage basin 86 to facilitate placement and retrieval of items to and from the storage basin 86. The storage basin 86 is coupled to the front frame section 38 and the rear frame section 40 and is arranged to lie at least partially below the seat-mode controller 20. The seat-mode controller 20 is configured to swing the juvenile seat 14 forward to the second single-function mode to position the first juvenile seat 14 at least partially offset from the storage basin 86 so that an entryway into the storage basin 86 is exposed from a rear end of the child transporter 10 adjacent to the handlebar 36. Similarly, the seat-mode controller 20 is configured to swing the juvenile seat 14 rearward to the third or fourth dual-function modes to position the first juvenile seat 14 at least partially offset from the storage basin 86 so that the entryway into the storage basin 86 is exposed from a front end of the child transporter 10.

The first juvenile seat 14 is separable from the seat-mode controller 20 so that an accessory 106 can be attached to the seat-mode controller 20 in any of the modes. For example, large bulky accessories can be attached to the seat-mode controller 20 in the third or fourth dual-function modes to provide sufficient spacing for the second juvenile seat 15 to remain attached to the second seat mount 46 with the accessory attached to the seat-mode controller 20. Some suitable accessories include an additional storage basket, a pet carrier, a platform, or a sidewall barrier. In illustrative embodiments, the platform can include a foot panel and wheels attached to the foot panel and configured to engage the ground when the seat-mode controller is in the fourth dual-function mode to provide a ride-along for a child. In illustrative embodiments, the platform can include a base panel configured to extend across the storage basin to provide a seating area for a child. In illustrative embodiments, the sidewall barrier can be coupled to the base panel to provide a barrier around the seating area such that the child transporter assumes a wagon mode when the seat-mode controller 20 is in the fourth dual-function mode.

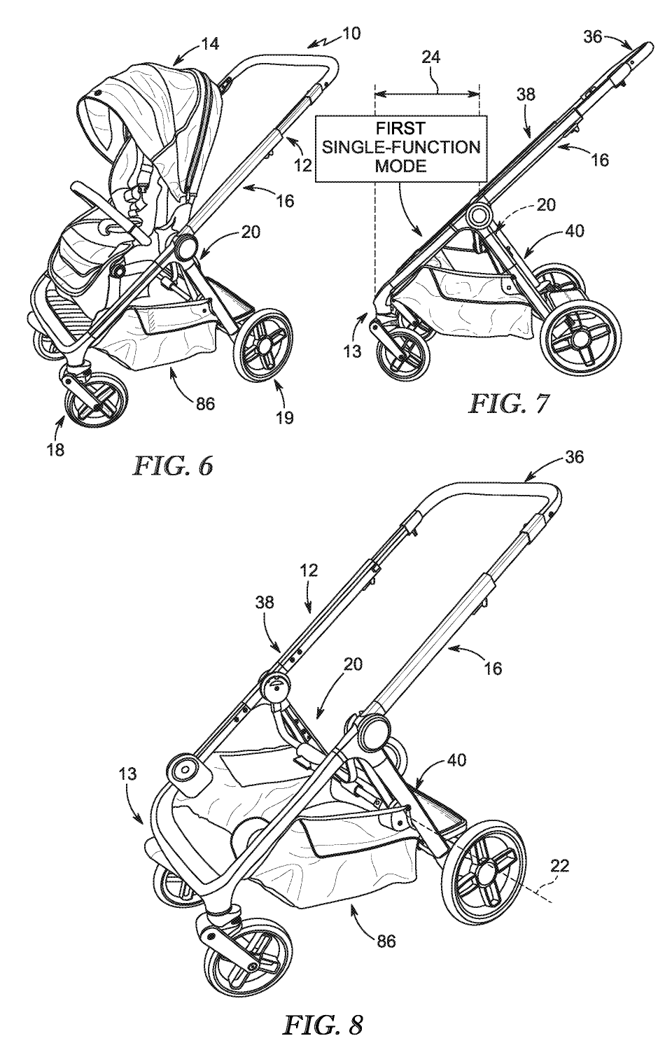

In illustrative embodiments, the front frame section 38 includes a front bumper 90, a first front support 92, and a second front support 94 as shown in FIGS. 6-11. The front bumper 90 is spaced apart from the handlebar 36 and is located at the front end 13 of the mobile cart 12. The front wheels 18 are coupled to the front bumper 90. The first front support 92 extends between and interconnects the front bumper 90 and the handlebar 36 along a first lateral side of the mobile cart 12. The second front support 94 extends between and interconnects the front bumper 90 and the handlebar 36 along a second lateral side of the mobile cart 12 opposite the first lateral side. The first and second front supports 92, 94 include at least two segments joined at a hub 93, 95 to allow the mobile cart 12 to fold and collapse. Further, the handlebar 36 includes telescopic portions 97 mounted to the first and second supports 92, 94 for translation relative thereto to adjust a position of the handlebar 36 relative to the front supports 92, 94.

The front seat anchor 34 includes a first front attachment 96 coupled to the first front support 92 and a second front attachment 98 coupled to the second front support 94 as shown in FIGS. 6-11. The first and second front attachments 96, 98 are located closer to the front bumper 90 than the handlebar 36. In particular, the first and second front attachments 96, 98 are located along at least 90% of a length of the first and second front supports 92, 94 spaced away from the handlebar 36. In some embodiments, the first and second front attachments 96, 98 may be repositionable along the length of the front supports 92, 94.

The rear frame section 40 includes a first rear leg 100, a second rear leg 102, and a rear crossbar 104 as shown in FIGS. 6-11. The first rear leg 100 is coupled to the first front support 92 at a location between the front bumper 90 and the handlebar 36. The second rear leg 102 is coupled to the second front support 94 at a location between the front bumper 90 and the handlebar 36. The rear crossbar 104 extends between and interconnects the first rear leg 100 and the second rear leg 102 at a location below the controller pivot axis 22 to locate the controller pivot axis 22 between the first and second front supports 92, 94 and the rear crossbar 104 along the first and second rear legs 100, 102. In some embodiments, the rear crossbar 104 includes a step.

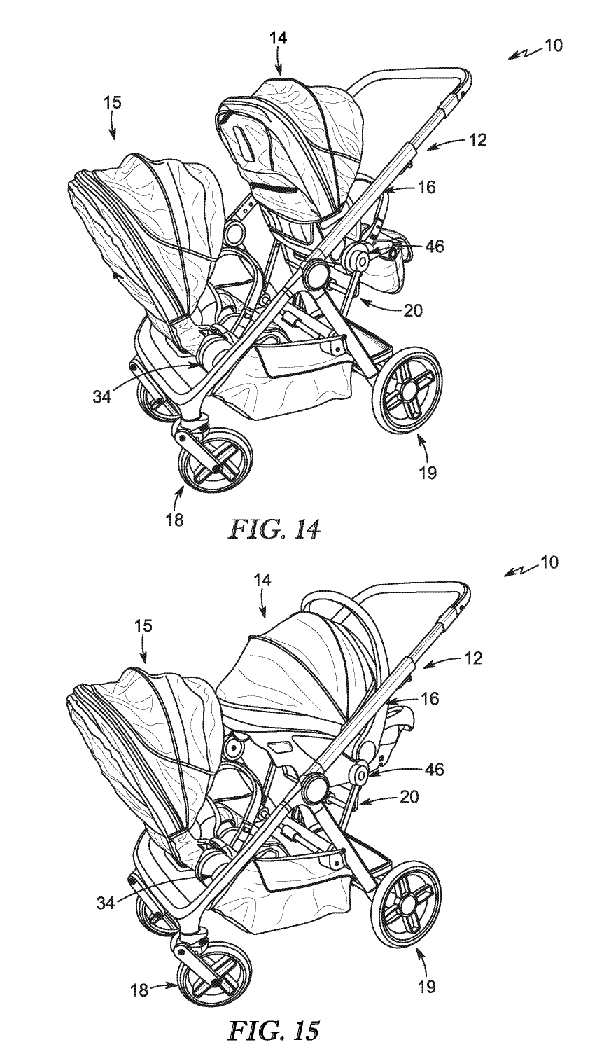

As shown in FIGS. 14 and 15, the first and second juvenile seats 14, 15 can be arranged in a rearward-facing orientation relative to the mobile cart 12 when the mobile cart 12 is in any of the dual-function modes. Further, either of the juvenile seats 14, 15 may be arranged in a forward-facing orientation, as shown in FIG. 6, while the other of the juvenile seats 14, 15 is in a rearward-facing orientation. The juvenile seats 14, 15 can include an infant carrier, a toddler seat, or any other suitable juvenile seat.

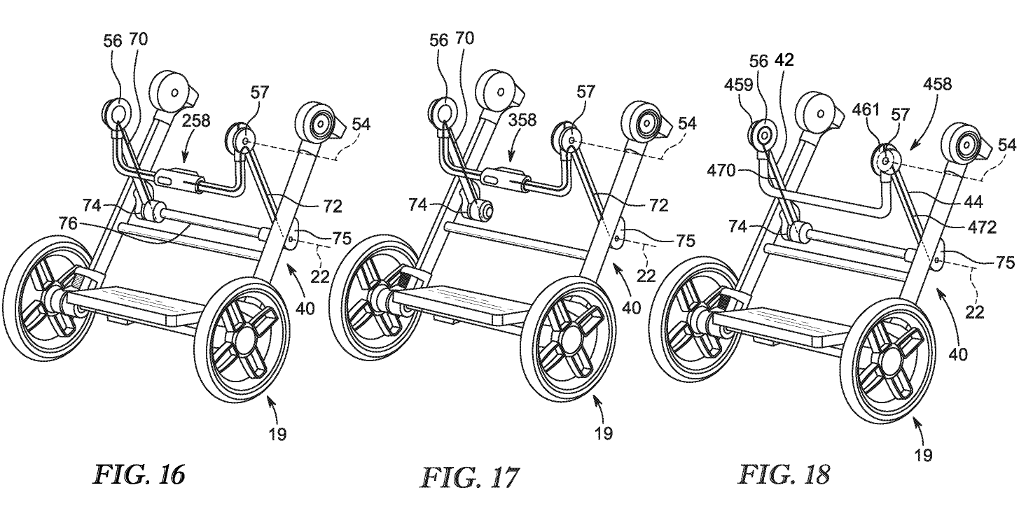

A second embodiment of an actuator 258 that can be used with the seat-mode controller 20 is shown in FIG. 16. The actuator 258 is configured to control movement of the entire seat-mode controller 20 about the controller pivot axis 22 and movement of the second seat mount 46 about the anchor pivot axis 54. In other words, actuating the actuator 258 simultaneously unlocks both the anchor latches 56, 57 and the separate latches 74, 75. In such an embodiment, the crossbar 76 does not include a second actuator. The actuator 258 may include additional latch movers or cables that extend from the latch release 68 to the additional latches 74, 75, or the cables 70, 72 may extend to both the anchor latches 56,57 and the additional latches 74, 75.

A third embodiment of an actuator 358 that can be used with the seat-mode controller 20 is shown in FIG. 17. The actuator 358 is identical to actuator 258, except the crossbar 76 is omitted.

A fourth embodiment of an actuator 458 that can be used with the seat-mode controller 20 is shown in FIG. 18. The actuator 458 includes a first release button 459 coupled to the distal end of the first connector rod 42, a second release button 461 coupled to the distal end of the second connector rod 44, a first latch cable 470 coupled to the first release button 459 and to a first separate latch 74, and a second latch cable 472 coupled to the second release button 461 and to a second separate latch 75. The first and second release buttons 459, 461 are configured to be pressed inwardly toward one another to release the anchor latches 56, 57. This movement also causes the cables 470, 472 to release the separate latches 74, 75.

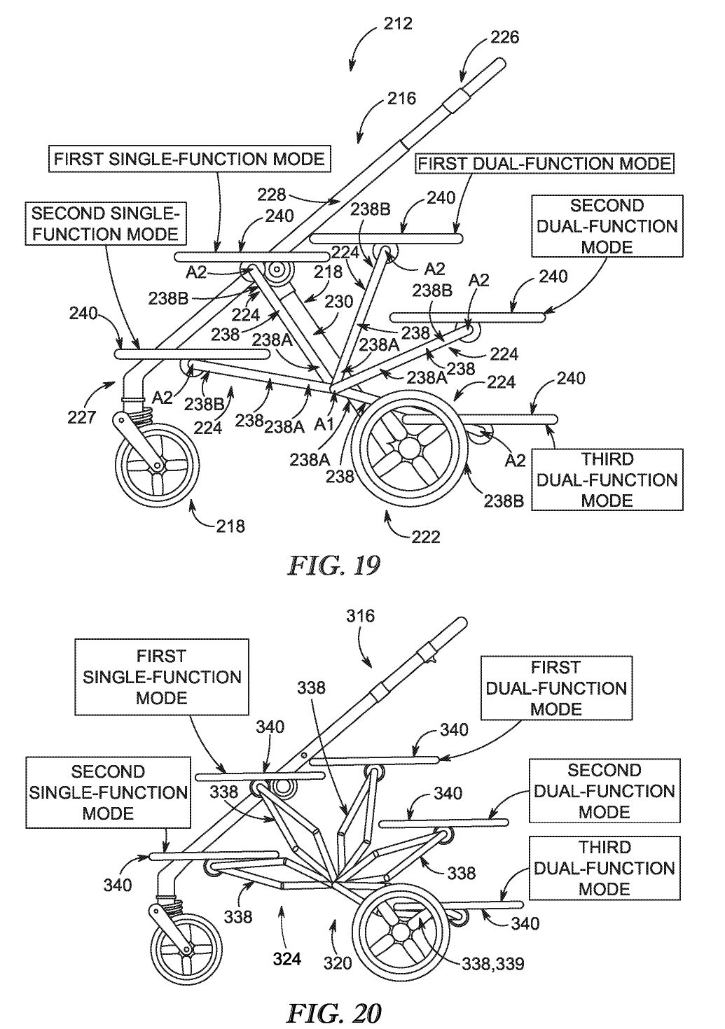

A second embodiment of a mobile cart 212 of a juvenile stroller 210 in accordance with the present disclosure is shown in FIG. 19 and is configured to move from a first single-function mode to one of a first dual-function mode, a second dual-function mode, a third dual-function mode, and a second single-function mode, similarly to child transporter 10. The juvenile stroller 210 includes the mobile cart 212 and a juvenile seat 214 selectively coupled to the mobile cart 212. The mobile cart 212 includes a frame 216 including front wheels 218, a rolling base 220 including rear wheels 222, and a seat-mode controller 224 coupled to the rolling base 220.

The frame 216 includes a handlebar 226, a front bumper 227, a first front support 228 arranged on a first side of the juvenile stroller 210, a second front support arranged on a second side of the juvenile stroller 210, and the front wheels 218 as shown in FIG. 19. The handlebar 226 is spaced apart from the front bumper 227. The handlebar 226 is coupled to the first front support 228 and the second front support 229 and extends between the first side and the second side of the juvenile stroller 210. The distance of the handlebar 226 from the front bumper 227 along a plane defined by the first front support 228 and the second front support may be adjustable. The first front support 228 is coupled to and extends between the handlebar 226 and the front bumper 227. The second front support is coupled to and extends between the handlebar 226 and the front bumper 227. The front bumper 227 is coupled to the first front support 228 and the second front support and extends between the first side and the second side of the juvenile stroller 210. The frame 216 may be changeable from an expanded-use mode to a collapsed-storage mode (not shown) so that the juvenile stroller 210 may be stored by a caregiver in a more compact profile.

The rolling base 220 includes a first rear leg 230 arranged on the first side of the juvenile stroller 210, a second rear leg arranged on the second side of the juvenile stroller 210, a rear bumper 232, and the rear wheels 222 as shown in FIG. 19. The first rear leg 230 is coupled to and extends between the first front support 228 and the rear bumper 232. The second rear leg is coupled to and extends between the second front support and the rear bumper. The first rear leg 230 couples to the first front support 228 at a first stroller hub 234 of the juvenile stroller 210, and the second rear leg couples to the second front support at a second stroller hub of the juvenile stroller 210. The rear bumper 232 is coupled to the first rear leg 230 and the second rear leg and extends between the first side and the second side of the juvenile stroller 210. The rear wheel 222 is coupled to at least one of the rear bumper 232 and the first rear leg 230 on the first side of the juvenile stroller 210. The rear wheel 223 is coupled to at least one of the rear bumper 232 and the second rear leg on the second side of the juvenile stroller 210.

The frame 216 further includes a pair of secondary seat anchors 236 coupled to the first front support 228 and the second front support, respectively, between the front bumper 227 and the first and second stroller hubs 234. The pair of secondary seat anchors 236 is configured to receive a second juvenile seat when the mobile cart 212 is in one of the first dual-function mode, the second dual-function mode, and the third dual-function mode. The second juvenile seat may be a toddler seat, an infant car seat, or an infant bassinet. The pair of secondary seat anchors 236 may be any suitable connector, adapter, support, or other means known in the art to selectively attach a juvenile seat to the frame 216.

The seat-mode controller 224 is configured to move the mobile cart 212 from the first single-function mode to one of the first dual-function mode, the second dual-function mode, the third dual-function mode, and the second single-function mode. The seat-mode controller 224 includes a first connecting rod 238 arranged on the first side of the juvenile stroller 210, a second connecting rod arranged on the second side of the juvenile stroller 210, and a tray 240. A leg-end 238A of the first connecting rod 238 is coupled to the first rear leg 230 and a leg-end of the second connecting rod is coupled to the second rear leg. The first connecting rod 238 and the second connecting rod 239 are rotatable about a first rotation axis A1 to change the mode of the mobile cart 212.

A tray-end 238B of the first connecting rod 238 is coupled to a first side of the tray 240 and a tray-end of the second connecting rod is coupled to a second side of the tray 240. The tray 240 is rotatable about a second rotation axis A2 to adjust the orientation of the tray 240 between the various modes of the mobile cart 212.

The tray 240 is configured to selectively receive the juvenile seat. The juvenile seat may be a toddler seat, an infant car seat, or an infant bassinet. The juvenile seat may be arranged on the tray 240 by mounting, coupling to, or connecting to one or more sides of the tray 240 and/or the juvenile seat may nest within the tray 240.

In the first single-function mode, the connecting rods 238 extend parallel to the rear legs 230 such that at least a portion of the tray 240 is arranged forward of the stroller hubs 234. When the mobile cart 212 is in the first single-function mode, a caregiver may arrange the juvenile seat in a forward-facing arrangement or in a rearward-facing arrangement. Optionally, the caregiver may not couple the juvenile seat to the tray 240 and instead attach another accessory to the tray 240, such as a storage basket or a pet carrier.

In the second single-function mode, the connecting rods 238 are rotated about the first rotation axis A1 to extend towards the front bumper 237 and the tray 240 is rotated about the second rotation axis A2 such that the tray 240 is proximate to and above the front bumper 237. When the mobile cart 212 is in the second single-function mode, a caregiver may arrange the juvenile seat in a forward-facing arrangement or in a rearward-facing arrangement. Optionally, the caregiver may not couple the juvenile seat to the tray 240 and instead attach another accessory to the tray 240, such as a storage basket or a pet carrier.

In the first dual-function mode, the connecting rods 238 are rotated about the first rotation axis A1 to extend rearward from the rear legs 230 and upward towards the handlebar 226 and the tray 240 is rotated about the second rotation axis A2 such that the tray 240 is arranged below and rearward of the frame 16 and proximate to the frame 216. When the mobile cart 212 is in the first dual-function mode, a caregiver may arrange the juvenile seat in a forward-facing arrangement or in a rearward-facing arrangement. The caregiver may also arrange the second juvenile seat in a forward-facing arrangement or in a rearward-facing arrangement. Optionally, the caregiver may not couple the juvenile seat to the tray 240 and instead attach another accessory to the tray 240, such as a storage basket or a pet carrier. In some embodiments, the caregiver may not couple the second juvenile seat to the mobile cart 212 when the mobile cart 212 is in the first dual-function mode.

In the second dual-function mode, the connecting rods 238 are rotated about the first rotation axis A1 to extend rearward from the rear legs 230 and relatively parallel to the frame 216 and the tray 240 is rotated about the second rotation axis A2 such that the tray 240 is arranged below and rearward of the frame 216 and spaced apart from the frame 216. When the mobile cart 212 is in the second dual-function mode, a caregiver may arrange the juvenile seat in a forward-facing arrangement or in a rearward-facing arrangement. The caregiver may also arrange the second juvenile seat in a forward-facing arrangement or in a rearward-facing arrangement. Optionally, the caregiver may not couple the juvenile seat to the tray 240 and instead attach another accessory to the tray 240, such as a storage basket or a pet carrier. In some embodiments, the caregiver may not couple the second juvenile seat to the mobile cart 212 when the mobile cart 212 is in the second dual-function mode.

In the third dual-function mode, the connecting rods 238 are rotated about the first rotation axis A1 to extend rearward and downward from the rear legs 230 and the tray 240 is rotated about the second rotation axis A2 such that the tray 240 is arranged below and rearward of the frame 216 and proximate to the rear wheels 222. When the mobile cart 212 is in the third dual-function mode, a caregiver may arrange the juvenile seat in a forward-facing arrangement or in a rearward-facing arrangement. The caregiver may also arrange the second juvenile seat in a forward-facing arrangement or in a rearward-facing arrangement. Optionally, the caregiver may not couple the juvenile seat to the tray 240 and instead attach another accessory to the tray 240, such as a storage basket, a pet carrier, or a juvenile ride along. In some embodiments, the caregiver may not couple the second juvenile seat to the mobile cart 212 when the mobile cart 212 is in the third dual-function mode.

Another embodiment of the seat-mode controller 324 is shown in FIG. 20. The seat-mode controller 324 is similar to the seat-mode controller 224. Accordingly, the disclosure of the seat-mode controller 224 is incorporated by reference herein for the seat-mode controller 324 except for the differences between the seat-mode controller 224 and the seat-mode controller 324 discussed below.

The seat-mode controller 324 includes a first connecting linkage 338 arranged on the first side of the juvenile stroller 310, a second connecting linkage arranged on the second side of the juvenile stroller 310, and a tray 340. The first connecting linkage 338 and the second connecting linkage are each a four-bar linkage. The four-bar linkage of the first and second connecting linkages 338 allow for the connecting linkages 338 to extend to different lengths and positions when the mobile cart 312 is in one of the first single-function mode, the second single-function mode, the first dual-function mode, the second dual-function mode, and the third dual-function mode. Accordingly, a caregiver may customize the position of the tray 340 relative to the rolling base 320 between the various modes of the mobile cart 312.

1. A child transporter comprising
a mobile cart including a frame, a plurality of wheels coupled to the frame to support the frame for movement across ground, and a front seat mount coupled to a front end of the frame, the frame including a handlebar configured to be gripped by a caregiver to push the mobile cart over the ground, a front frame section coupled to the handlebar and a pair of front wheels included in the plurality of wheels, and a rear frame section coupled to the front frame section and a pair of rear wheels included in the plurality of wheels,
a first juvenile seat configured to hold a child for transportation, and
a seat-mode controller coupled to the rear frame section and configured to mount the juvenile seat to the frame for pivotable movement relative to the rear frame section about a controller pivot axis to change the child transporter from a single-function mode, in which the first juvenile seat is positioned a first distance from a front end of the frame, to a dual-function mode, in which the first juvenile seat is positioned a second distance, greater than the first distance, from the front end of the frame so that a second juvenile seat can be attached to the front seat mount for transportation with the first juvenile seat on the mobile cart.

2. The child transporter of claim 1, wherein the seat-mode controller includes a first connector rod coupled to a first lateral side of the rear frame section, a second connector rod coupled to a second lateral side of the rear frame section, and a second seat mount coupled to a distal end of the first connector rod and the second connector rod and configured to mount the first juvenile seat to the seat-mode controller.

3. The child transporter of claim 2, wherein the second seat mount includes a first seat anchor coupled to the distal end of the first connector rod, a second seat anchor coupled to the distal end of the second connector rod, and an anchor position controller configured to pivot the first seat anchor and the second seat anchor relative to the first connector rod and the second connector rod about an anchor pivot axis as the seat-mode controller pivots about the controller pivot axis so that the first seat anchor and the second seat anchor provide a level mounting position for the first juvenile seat in both the single function mode and the dual function mode.

4. The child transporter of claim 3, wherein the anchor position controller includes an anchor latch configured to block pivotable movement of the first and second seat anchors about the anchor pivot axis in a locked position, an actuator configured to move the anchor latch from the locked position to an unlocked position, in which the first seat anchor and the second seat anchor are free to pivot about an anchor pivot axis spaced apart from the controller pivot axis, and a pivot lever having a first lever arm coupled to the first seat anchor, a second lever arm coupled to the second seat anchor, and a lever crossbar interconnecting the first lever arm and the second lever arm and spaced apart from the first seat anchor and the second seat anchor.

5. The child transporter of claim 2, wherein seat-mode controller further includes a controller crossbar extending between and interconnecting a proximal end of the first connector rod and the second connector rod along the controller pivot axis and an actuator coupled to the crossbar and configured to unlock the seat-pivot controller for pivotable movement relative to the frame about the controller pivot axis.

6. The child transporter of claim 1, wherein the seat-mode controller is configured to change the child transporter to a second dual-function mode, in which the first juvenile seat is spaced a third distance from the front end of the mobile cart, the third distance being greater than the second distance.

7. The child transporter of claim 6, wherein the seat-mode controller is configured to change the child transporter to a third dual-function mode, in which the first juvenile seat is spaced a fourth distance from the front end of the mobile cart, the fourth distance being greater than the third distance.

8. The child transporter of claim 7, wherein the first juvenile seat is separable from the seat-mode controller in the third dual-function mode so that an accessory can be attached to the seat-mode controller.

9. The child transporter of claim 7, wherein the seat-mode controller is configured to change the child transporter to a second single-function mode in which the second juvenile seat is removed from the mobile cart and the first juvenile seat is spaced a fifth distance from the front end of the mobile cart less than the first distance.

10. The child transporter of claim 9, wherein the mobile cart further includes a storage basin coupled to the front frame section and the rear frame section and arranged to lie below the seat-mode controller, and wherein the first juvenile seat is at least partially offset from the storage basin in the second single-function mode so that an entryway into the storage basin is exposed from a rear end of the child transporter adjacent to the handlebar.

11. The child transporter of claim 1, wherein the front frame section includes a front bumper spaced apart from the handlebar and located at the front end of the mobile cart, a first front support extending between and interconnecting the front bumper and the handlebar along a first lateral side of the mobile cart, and a second front support extending between and interconnecting the front bumper and the handlebar along a second lateral side of the mobile cart opposite the second lateral side,
wherein the front seat mount includes a first front attachment coupled to the first front support and a second front attachment coupled to the second front support, the first and second front attachments being located closer to the front bumper than the handlebar, and
wherein the rear frame section includes a first rear leg coupled to the first front support at a location between the front bumper and the handlebar, a second rear leg coupled to the second front support at a location between the front bumper and the handlebar, and a rear crossbar extending between and interconnecting the first rear leg and the second rear leg at a location below the controller pivot axis to locate the controller pivot axis between the first and second front supports and the rear crossbar along the first and second rear legs.

12. A child transporter comprising
a mobile cart including a frame and a plurality of wheels coupled to the frame to support the frame for movement across ground,
a juvenile seat configured to hold a child for transportation, and
a seat-mode controller coupled to the frame and configured to mount the juvenile seat to the mobile cart for pivotable movement relative to the mobile cart about a controller pivot axis to change the child transporter from a single-function mode, in which the first juvenile seat is positioned a first distance from a front end of the frame, to a dual-function mode, in which the first juvenile seat is positioned a second distance, greater than the first distance, from the front end of the frame.

13. The child transporter of claim 12, wherein the seat-mode controller includes a first connector coupled to a first lateral side of the frame, a second connector coupled to a second lateral side of the frame, and a seat mount coupled to a distal end of the first connector and the second connector and configured to mount the juvenile seat to the seat-mode controller.

14. The child transporter of claim 13, wherein the seat mount includes a first seat anchor coupled to the distal end of the first connector, a second seat anchor coupled to the distal end of the second connector, and an anchor position controller configured to pivot the first seat anchor and the second seat anchor relative to the first connector and the second connector about an anchor pivot axis to adjust a recline orientation of the juvenile seat relative to the mobile cart.

15. The child transporter of claim 14, wherein the anchor position controller includes an anchor latch configured to block pivotable movement of the first and second seat anchors about the anchor pivot axis in a locked position, an actuator configured to move the anchor latch from the locked position to an unlocked position, in which the first seat anchor and the second seat anchor are free to pivot about an anchor pivot axis spaced apart from the controller pivot axis, and a pivot lever having a first lever arm coupled to the first seat anchor, a second lever arm coupled to the second seat anchor, and a lever crossbar interconnecting the first lever arm and the second lever arm and spaced apart from the first seat anchor and the second seat anchor, the actuator being coupled to the lever crossbar.

16. The child transporter of claim 13, wherein seat-mode controller further includes a controller crossbar extending between and interconnecting a proximal end of the first connector and the second connector along the controller pivot axis and an actuator configured to unlock the seat-pivot controller for pivotable movement relative to the frame about the controller pivot axis.

17. The child transporter of claim 12, wherein the seat-mode controller is configured to change the child transporter to a second dual-function mode, in which the juvenile seat is spaced a third distance from the front end of the mobile cart, the third distance being greater than the second distance.

18. The child transporter of claim 17, wherein the seat-mode controller is configured to change the child transporter to a third dual-function mode, in which the juvenile seat is spaced a fourth distance from the front end of the mobile cart, the fourth distance being greater than the third distance.

19. The child transporter of claim 18, wherein the seat-mode controller is configured to change the child transporter to a second single-function mode in which the juvenile seat is spaced a fifth distance from the front end of the mobile cart less than the first distance, and
wherein the mobile cart further includes a storage basin coupled to the front frame section and the rear frame section and arranged to lie below the seat-mode controller, and wherein the juvenile seat is at least partially offset from the storage basin in the second single-function mode so that an entryway into the storage basin is exposed from a rear end of the child transporter.

20. The child transporter of claim 12, wherein the frame includes a handlebar, a front frame section coupled to the handlebar, and a rear frame section coupled to the front frame section, the seat mode controller being coupled to the rear frame section,
wherein the front frame section includes a front bumper spaced apart from the handlebar and located at the front end of the mobile cart, a first front support extending between and interconnecting the front bumper and the handlebar along a first lateral side of the mobile cart, and a second front support extending between and interconnecting the front bumper and the handlebar along a second lateral side of the mobile cart opposite the second lateral side, and
wherein the rear frame section includes a first rear leg coupled to the first front support at a location between the front bumper and the handlebar, a second rear leg coupled to the second front support at a location between the front bumper and the handlebar, and a rear crossbar extending between and interconnecting the first rear leg and the second rear leg at a location below the controller pivot axis to locate the controller pivot axis between the first and second front supports and the rear crossbar along the first and second rear legs.
